(19) United States
(12) Patent Application Publication
(10) Pub. No.: US 2008/0111485 A1
(43) Pub. Date: May 15, 2008

(54) PLASMA DISPLAY PANEL

(75) Inventors: Chong-Gi HONG, Yongin-si (KR); Tae-Kyoung Kang, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/756,738

(22) Filed: Jun. 1, 2007

(30) Foreign Application Priority Data
Nov. 15, 2006 (KR) 10-2006-0112807

(51) Int. Cl. H01J 17/49

(52) U.S. Cl. 313/586

(57) ABSTRACT

A plasma display panel includes first and second substrates facing and spaced apart from each other, barrier ribs disposed between the first and second substrates to define discharge cells, address electrodes formed on the first substrate and extending in a first direction to correspond to the discharge cells, first and second electrodes formed on the second substrate and extending in a second direction crossing the first direction to correspond to the discharge cells, and a dielectric layer formed on the second substrate to cover the first and second electrodes. The first and second electrodes each include a plurality of bus lines of which some of the bus lines form discharge gaps at a central portion of the respective discharge cells. The dielectric layer is provided with grooves formed within the discharge gaps to decrease the requisite firing voltage and improve the light emission efficiency of the panel.

### CROSS-REFERENCE TO RELATED APPLICATIONS

This application claims the benefit of Korean Application No. 2006-112807, filed Nov. 15, 2006, in the Korean Intellectual Property Office, the disclosure of which is incorporated herein by reference.

### BACKGROUND OF THE INVENTION

1. Field of the Invention

Aspects of the present invention relate to a plasma display panel and, more particularly, to a plasma display panel that can decrease an amount of absorption of visible light produced in the discharge cells and improve luminance by increasing an aperture ratio of a discharge cell.

2. Description of the Related Art

Generally, a plasma display panel is a display device that can display an image using red, green, and blue visible light created by exciting phosphors using vacuum ultraviolet (VUV) rays emitted from plasma created by a gas discharge.

For example, in an alternating current (AC) plasma display panel, address electrodes are formed on a rear substrate. The address electrodes are covered by a dielectric layer, and barrier ribs are arranged on the dielectric layer between the address electrodes. Red, green, and blue phosphor layers are formed on an inner surface of the barrier ribs as well as on the dielectric layer.

Sustain and scan electrodes are formed on a surface of a front substrate that faces the rear substrate. The sustain and scan electrodes extend in a direction crossing the address electrodes and are covered by a dielectric layer and a MgO protective layer.

Discharge cells are formed in regions where the address electrodes formed on the rear substrate cross the sustain and scan electrodes formed on the front substrate. Several million of the discharge cells are arranged in a matrix pattern in the plasma display panel.

A memory property is used for driving the discharge cells of the plasma display panel. In more detail, in order to generate the discharge between the sustain and scan electrodes, a potential difference higher than a specific voltage is required. This boundary voltage is called a firing voltage (Vf).

When the scan and the address voltages are respectively applied to the scan and address electrodes, the discharge is generated between the scan and address electrodes to generate plasma in the discharge cell. Electrons and ions of the plasma travel to the electrode that has a polarity opposite to those of the electrons and ions.

A dielectric layer is deposited on each electrode of the plasma display panel so that most of the space charges are accumulated on the dielectric layer that covers the electrode that has the polarity opposite the space charges. As a result, as net space potential between the scan and address electrodes is to be lower than an initially applied address voltage (Va), the address discharge is weakened and dissipated.

At this point, a relatively small amount of electrons are accumulated on the surface of the dielectric layer that covers the sustain electrodes, and a relatively large amount of electrons are accumulated on the surface of the dielectric layer that covers the scan electrodes. The charges accumulated on the dielectric layer covering the sustain and scan electrodes are called wall charges (Qw). A space voltage generated between the sustain and scan electrodes by the wall charges is called a wall voltage (Vw).

When a discharge sustain voltage (Vs) is applied to the sustain and scan electrodes and a sum (Vs+Vw) of the discharge sustain voltage (Vs) and the wall voltage (Vw) is higher than the firing voltage (Vf), a sustain discharge occurs in the discharge cells, thereby generating vacuum ultraviolet rays. The vacuum ultraviolet rays excite the corresponding phosphor layer to emit visible light through the transparent front panel.

However, when there is no address discharge between the scan and address electrodes (i.e., when no address voltage (Va) is applied), no wall charges accumulate between the sustain and scan electrodes. As a result, no wall voltage exists between the sustain and scan electrodes. At this point, only the discharge sustain voltage (Vs) applied to the sustain and scan electrodes is formed in the discharge cells. Since the discharge sustain voltage is lower than the firing voltage (Vf), the gas space defined between the sustain and scan electrodes is not discharged so that no visible light is emitted from the associated phosphor layer.

Each of the sustain and scan electrodes includes transparent electrodes disposed on the surface of the front substrate in an area corresponding to the discharge cell to directly generate the discharge and bus electrodes to apply a voltage to the transparent electrodes. That is, the transparent electrodes of the respective sustain and scan electrodes are provided in front of the discharge cell—the area through which visible light is to be emitted. However, even the transparent electrodes intercept a large amount of the visible light that is generated from the discharge cell. Therefore, as the transparent electrodes occupy most of the front portion of the discharge cell, the luminance is further deteriorated.

In addition, the bus electrode includes a black layer and a white layer. The black layer reduces external light reflection to thereby improve the bright room contrast, but since the black layer absorbs a large amount of the visible light emitted frontward from the discharge cell, the luminance is deteriorated.

### SUMMARY OF THE INVENTION

Aspects of the present invention provide a plasma display panel that can enhance the luminance by decreasing an amount of absorption of visible light generated in the discharge cells and increasing an aperture ratio.

According to an embodiment of the present invention, a plasma display panel includes: first and second substrates facing each other and spaced apart from each other; barrier ribs disposed between the first and second substrates to define discharge cells; an address electrode formed on the first substrate and extending in a first direction to correspond to the discharge cells; first and second electrodes formed on the second substrate and extending in a second direction crossing the first direction to correspond to the discharge cells; and a dielectric layer formed on the second substrate and covering the first and second electrodes. The first and second electrodes each include a plurality of bus lines of which some of the bus lines form discharge gaps at a central portion of the respective discharge cells, and the grooves are formed within the discharge gap. The grooves are separately formed in each of the discharge cells.

Each of the first and second electrodes may include first bus lines arranged at both sides of the discharge cell in the first direction and extending in the second direction, and second bus lines spaced apart from the respective first bus lines in the first direction and arranged in parallel to the first bus line, and the second bus lines form the discharge gap. Each of the first and second electrodes may further include short bars to connect the first bus lines and the second bus lines at a central portion of the discharge cell with respect to the second direction.

Each of the first and second bus lines and short bars may include a black layer formed on the second substrate and a white layer formed on the black layer. Each of the first bus lines and short bars may include a black layer formed on the second substrate and a white layer formed on the black layer, and each of the second bus lines may include a white layer formed on the second substrate. Each of the first bus lines may include a black layer formed on the second substrate and a white layer formed on the black layer, and each of the short bars and second bus lines includes a white layer formed on the second substrate. Each of the first bus lines, short bars, and second bus lines may include a white layer formed on the second substrate.

The plasma display according to aspects of the present invention may further include a protective layer formed on a surface of the dielectric layer and inner sidewalls of the grooves. The dielectric layer may be colored with blue, and the barrier ribs may be colored with brown.

According to another aspect of the present invention, a plasma display panel includes: first and second substrates facing each other and spaced apart from each other; barrier ribs disposed between the first and second substrates and dividing discharge cells; an address electrode formed on the first substrate and extending in a first direction to correspond to the discharge cells; first and second electrodes formed on the second substrate and extending in a second direction crossing the first direction to correspond to the discharge cells; and a dielectric layer formed on the second substrate to cover the first and second electrodes and comprising grooves in a surface of the dielectric layer facing the discharge cells. The first and second electrodes each include a plurality of bus lines of which some of the bus lines form a discharge gap; and at least one of the bus lines is formed of a white layer.

Each of the first and second electrodes may include: first bus lines arranged at both sides of the discharge cell in the first direction and extending in the second direction; second bus lines spaced apart from the respective first bus lines in the first direction and arranged in parallel to the first bus line, the second bus lines forming the discharge gap; and short bars for connecting the first bus lines to the second bus lines at a central portion of the discharge cell.

Each of the first bus lines and short bars may be formed of black and white layers, and each of the second bus lines may be formed of a white layer. Each of the first bus lines may be formed of black and white layers, and each of the short bars and second bus lines may be formed of a white layer. Each of the first bus lines, short bars, and second bus lines may be formed of a white layer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a plasma display panel according to a first embodiment of the present invention;

FIG. 2 is a cross-sectional view taken along line II-II of FIG. 1;

FIG. 3 is a cross-sectional view taken along line III-III of FIG. 1;

FIG. 4 is a top view illustrating an arrangement of the barrier ribs and electrodes;

FIG. 5 is a top view illustrating an arrangement of electrodes with respect to one discharge cell in a plasma display panel according to a second embodiment of the present invention;

FIG. 6 is a partial cross-sectional view taken along line VI-VI of FIG. 5;

FIG. 7 is a partial cross-sectional view illustrating an electrode and a dielectric layer in a plasma display panel according to a third embodiment of the present invention; and

FIG. 8 is a partial cross-sectional view of an electrode and a dielectric layer in a plasma display panel according to a fourth embodiment of the present invention.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below in order to explain aspects of the present invention by referring to the figures. Aspects of the present invention may, however, be embodied in different forms and should not be construed as limited to the embodiments set forth herein. When it is mentioned that a layer or an electrode is said to be “disposed on” or “formed on” another layer or a substrate, the phrase means that the layer or electrode may be directly formed on the other layer or substrate, or that a third layer may be disposed therebetween. In addition, the thickness of layers and regions may be exaggerated for clarity.

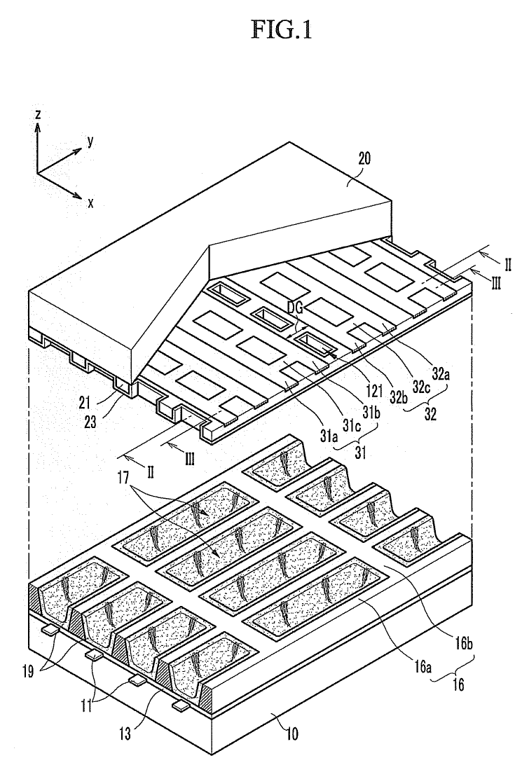

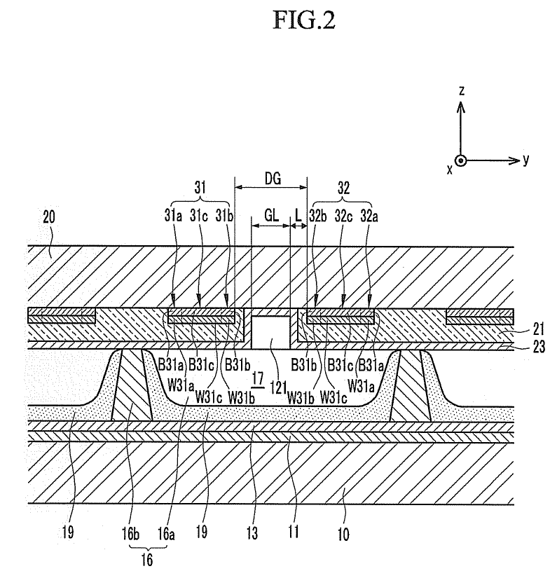

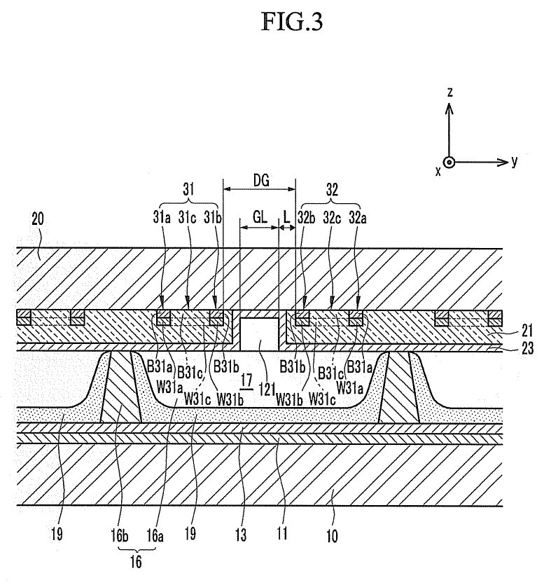

FIG. 1 is an exploded perspective view of a plasma display panel according to a first embodiment of the present invention, FIG. 2 is a cross-sectional view taken along line II-II of FIG. 1, and FIG. 3 is a cross-sectional view taken along line III-III of FIG. 1.

Referring to FIGS. 1 through 3, a plasma display panel of a first embodiment includes first and second substrates (hereinafter, “rear and front substrates”) 10 and 20, respectively, that face each other and are sealed together at a predetermined interval. Barrier ribs 16 are disposed between the rear and front substrates 10 and 20.

The barrier ribs 16 are formed with a predetermined height between the rear and front substrates 10 and 20 to define a plurality of discharge cells 17. The discharge cells 17 are filled with discharge gas (e.g., a mixture gas including neon (Ne) and xenon (Xe)) to create vacuum or far ultraviolet rays through a gas discharge. The discharge cells 17 have phosphor layers 19 for absorbing the vacuum ultraviolet rays and emitting visible light.

In order to display an image using the gas discharge, the plasma display panel includes address electrodes 11, first electrodes (hereinafter, “sustain electrodes”) 31, and second electrodes (hereinafter, “scan electrodes”) 32. The address, sustain, and scan electrodes 11, 31, and 32, respectively, are arranged between the rear and front substrates 10 and 20 to correspond to the discharge cells 17.

The address electrodes 11 extend in a first direction (the y-axis in the drawings) on an inner surface of the rear substrate 10 to continuously correspond to the discharge cells 18 that are adjacent to each other along the y-axis. In addition, the address electrodes 11 are arranged in parallel in response to the discharge cells 17 that are adjacent to each other in a second direction (the x-axis in the drawings) crossing the y-axis. The address electrodes 11 may be arranged on the surface of the rear substrate, and the sustain and scan electrodes 31 and 32 may be formed on the front substrate. However, the address, sustain, and scan electrodes 11, 31, and 32 are not limited thereto. For example, the address, sustain, and scan electrodes 11, 31, and 32, or any combination thereof may be formed on the surfaces of the rear and front substrates 10 and 20 or in the barrier ribs 16.

As described above, the address electrodes 11 are covered by a first dielectric layer 13 deposited on an inner surface of the rear substrate 10. The dielectric layer 13 prevents the address electrodes 11 from being damaged by preventing positive ions or electrons from directly colliding with the address electrodes 11. Further, the dielectric layer 13 generates and accumulates wall charges.

Since the address electrodes 11 are arranged on the rear substrate 10 so as not to interfere with the irradiation of the visible light toward the front substrate 20, the address electrodes 11 may be formed of a non-transparent material. For example, the address electrodes 11 may be formed of metal (e.g., silver (Ag)) that has a superior conductivity.

The barrier ribs 16 are provided on the first dielectric layer 13 of the rear substrate to form the discharge cells 17. For example, the barrier ribs 16 include first barrier rib members 16a extending in parallel in the first direction of the y-axis and second barrier rib members 16b extending in parallel in the second direction of the x-axis and spaced apart from each other by a predetermined distance in the first direction of the y-axis. The second barrier rib members 16b extend between the first barrier rib members 16a. The first and second barrier rib members 16a and 16b form the discharge cells 17 in a matrix structure.

Alternatively, the barrier ribs 16 may include first barrier rib members to extend in the first direction of the y-axis and spaced apart from each other in the second direction of the x-axis without requiring a structure, such as the second barrier rib members 16b, to cross the barrier ribs 16 in the second direction of the x-axis. The first barrier rib members 16a may form the discharge cells in a stripe structure without the second barrier rib members 16b. Further, the barrier ribs 16 are not limited to the above described structures. For example, the barrier ribs 16 may be formed in a single sheet to be disposed between the front and rear substrates 20 and 10 in which circular discharge cells 17 are arranged.

As illustrated in FIG. 1, the barrier ribs 16 form the discharge cells 17 in the matrix structure. From the described matrix structure, if the second barrier rib members 16b are removed, the discharge cells 17 are formed in the stripe structure by only the first barrier rib members 16a. Therefore, a drawing illustrating the discharge cells 17 formed in the stripe structure will be omitted herein.

The phosphor layers 19 formed in each of the discharge cells 17 are formed by printing or depositing fluorescent paste on a sidewall of the barrier ribs 16 and a surface of the first dielectric layer 13 surrounded by the barrier ribs 16 through a printing or dispensing process. The printed or deposited fluorescent paste is then dried or fired.

The phosphor layers 19 formed in the discharge cells 17 arranged in the first direction of the y-axis are formed of phosphors of an identical color. In addition, the phosphor layers 19 formed in the discharge cells 17 arranged in the second direction of the x-axis may be formed of alternating red, green, and blue phosphors R, G, and B, respectively.

The sustain and scan electrodes 31 and 32 are provided on an inner surface of the front substrate 20 to form surface discharge structures to correspond to the respective discharge cells 17. The sustain and scan electrodes 31 and 32 induce the gas discharge in the discharge cells 17.

Referring again to FIGS. 1 through 3, the sustain and scan electrodes 31 and 32 cross the address electrodes 11 separated by a distance in a third direction of the z-axis in an area that corresponds to the discharge cells 17. The sustain and scan electrodes 31 and 32 are covered by a second dielectric layer 21 while facing the address electrodes 11 such that the sustain and scan electrodes 31 and 32 are disposed on a surface of the front substrate 20 between the front and rear substrates 20 and 10 and the sustain and scan electrodes 31 and 32 are covered by the second dielectric layer 21. The second dielectric layer 21 protects the sustain and scan electrodes 31 and 32 from the gas discharge and generates and accumulates the wall charges during the discharge. Further, the second dielectric layer 21 is covered by a protective layer 23. For example, the protective layer 23 is formed of transparent MgO to protect the second dielectric layer 21 from the discharge and increase the second electron emission coefficient during the discharge.

The sustain and scan electrodes 31 and 32 include a plurality of bus lines. Among the bus lines, some bus lines facing each other at a central portion of the discharge cell 17 form a discharge gap DG therebetween. For example, the sustain electrodes 31 each include first bus lines 31a, second bus lines 31b, and short bars 31c. And, scan electrodes 32 each include first bus lines 32a, second bus lines 32b, and short bars 32c. The first bus lines 31a and 32a extend in parallel in the second direction of the x-axis and are respectively arranged at each end of the discharge cells 17 and are separated in the first direction of the y-axis. The second bus lines 31b and 32b extend in the second direction of the x-axis and are spaced apart from the respective first bus lines 31a and 32a in the first direction of the y-axis. The second bus lines 31b and 32b are parallel with each other and parallel with the first bus lines 31a and 32a. The second bus lines 31b and 32b are disposed in a central portion of the discharge cell 17 such that the second bus lines 31b and 32b are disposed between the first bus lines 31a and 32a. The second bus lines 31b and 32b form the discharge gap DG at the central portion of the discharge cell 17.

The short bars 31c and 32c are formed in the first direction of the y-axis at the central portion of the discharge cell 17 to electrically interconnect the first bus lines 31a and 32a and the second bus lines 31b and 32b. The short bars 31c and 32c apply a voltage signal applied to the first bus lines 31a and 32a to the second bus lines 31b and 32b and diffuse the discharge generated at the central portion of the discharge cell 17 to both sides of the discharge cell 17.

The first bus lines 31a and 32a, the second bus lines 31b and 32b, and the short bars 31c and 32c are arranged on the inner surface of the front substrate 20 and formed of a non-transparent metal having superior conductivity. For example, the first bus lines 31a and 32a, the second bus lines 31b and 32b, and the short bars 31c and 32c may be formed of silver (Ag), platinum (Pt), palladium (Pd), nickel (Ni), or a material containing or mixture thereof.

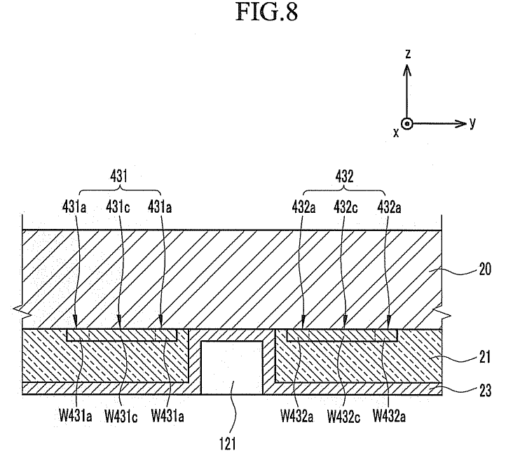

Referring specifically to FIGS. 2 and 3, the first bus lines 31a and 32a, the second bus lines 31b and 32b, and the short bars 31a and 32a of the sustain and scan electrodes 31 and 32 include black layers B31a, B32a; B31b, B32b; B31c, B32c, and white layers W31a, W32a; W31b, W32b; W31c, W32c. In addition, with reference to the first embodiment where each of the sustain and scan electrodes 31 and 32 includes the black and white layers, at least one of the first bus line 31a, 32a, the second bus line 31b, 32b, and the short bar 31c, 32c of each of the sustain and scan electrodes 31 and 32 may be formed with one white layer (see FIG. 8).

FIGS. 2 and 3 illustrate the black and white layers of the sustain and scan electrodes 31 and 32 in relation to the first and second substrates 10 and 20. The address electrodes 11 are disposed on the surface of the first substrate 10 between the first and second substrates 10 and 20. The first dielectric layer 13 is disposed to cover the address electrodes 11. The barrier ribs 16, including the first and second barrier rib members 16a and 16b, are disposed on the surface of the first dielectric layer 13. The phosphor layers 19 are formed on the barrier ribs 16 and the surface of the first dielectric layer 13 in the discharge cells 17.

Describing the first embodiment with reference to FIGS. 2 and 3, the black layers B31a, B32a; B31b, B32b; B31c, and B32c are formed on the front substrate 20 to absorb external light, thereby enhancing the bright room contrast. In addition, the black layers B31a, B32a; B31b, B32b; B31c, B32c partly absorb the visible light emitted frontward from the discharge cell 17, thereby decreasing the luminance. The white layers W31a, W32a; W31b, W32b; W31c, and W32c improve the conductivity of the sustain and scan electrodes 31 and 32 and minimize an amount of absorption of the visible light emitted frontward from the discharge cell 17 while maximizing an amount of the reflection of the visible light, thereby improving the luminance. Therefore, as an area of the black layer B31a, B32a; B31b, B32b; B31c, and B32c in each of the sustain and scan electrodes 31 and 32 increases, the bright room contrast is deteriorated but the luminance is improved.

When the plasma display panel is driven, a reset pulse is applied to the scan electrodes 32 during a reset period to effect a reset discharge, and a scan pulse is applied to the scan electrodes 32 and an address pulse is applied to the address electrodes 11 to effect an address discharge during an address period, which follows the reset period. Then, a sustain pulse is applied to the sustain and scan electrodes 31 and 32 to effect a sustain discharge during a sustain period.

The sustain and scan electrodes 31 and 32 function as electrodes for applying the sustain pulse required for the sustain discharge. The scan electrodes 32 function as electrodes for applying the reset and scan pulses. The address electrodes 11 function as electrodes for applying the address pulse. The sustain, scan, and address electrodes 31, 32, and 11 may vary their functions depending on voltage waveforms respectively applied thereto. Therefore, the functions are not limited to the above description.

The plasma display panel selects discharge cells 17 that will be turned on by the address discharge occurring by the interaction between the address and scan electrodes 11 and 32 and drives the selected discharge cells 17 using the sustain discharge occurring by the interaction between the sustain and scan electrodes 31 and 32, to thereby display an image.

As shown in FIGS. 2 and 3, the second dielectric layer 21 covering the sustain and scan electrodes 31 and 32 is provided with a groove 121 disposed in the discharge gap DG. The groove 121 is formed in the second dielectric layer 21 corresponding to the discharge cell 17 with respect to an x-y plane of the front substrate 20. That is, the groove 121 of the second dielectric layer 21 is spatially connected to the discharge cell 17 and not formed above the barrier ribs 16.

The protective layer 23 is formed on surfaces of the dielectric layer 21 that form the groove 121 and an inner surface of the second dielectric layer 21. The protective layer 23 is further formed on an inner surface of the front substrate 20 surrounded by the groove 121. Therefore, the protective layer 23 protects the second dielectric layer 21 and the front substrate 20 from the discharge in the discharge cell 17.

Generally, a firing voltage Vf is determined depending on the discharge gap DG defined by a distance between the sustain and scan electrodes 31 and 32. That is, as the discharge gap DG increases, the firing voltage Vf increases. On the contrary, as the discharge gap DG decreases, the firing voltage VF decreases.

In addition, when the groove 121 is provided in the discharge gap DG, the firing voltage VF is also determined by a length GL of the groove 121 in the first direction of the y-axis. That is, as the length GL of the groove 121 in the first direction of the y-axis increases, the firing voltage Vf decreases. As the length GL of the groove 121 in the first direction of the y-axis decreases, the firing voltage Vf increases. That is, the y-axis length GL of the groove 121 formed in the second dielectric layer 21 determines a distance L between the second bus lines 31b and 32b and the groove 121 in the first direction of the y-axis. The distance in the first direction of the y-axis between the second bus lines 31b and 32b is the sum of two times the distance L plus the length GL. Therefore, when the length GL of the groove 121 in the first direction of the y-axis increases, the distance L between the second bus lines 31b and 32b and the groove 121 facing the second bus lines 31b and 32b decreases, the firing voltage Vf is lowered.

As the distance L between the second bus lines 31b and 32b and the groove 121 facing the second bus lines 31b and 32b decreases, i.e., as a thickness of the second dielectric layer 21 is reduced in the first direction of the y-axis, capacitance C17 between the sustain and scan electrodes 31 and 32 increases and the ability of the address, sustain, and scan electrodes 11, 31, and 32 to generate wall charges is improved, thereby decreasing the voltage required to effect the sustain discharge. Although the groove is illustrated as having walls that extend through the second dielectric layer 21 in a third direction (the direction of the z-axis), the groove 121 is not limited thereto. The groove 121 may be formed to include walls that are angled so as to be wider or narrower nearer one of the rear and front substrates 10 and 20.

As in the following Formula 1, the capacitance C17 of the discharge cell 17 becomes a sum of both capacitances C21 of the second dielectric layer 21, each of which has a distance L between the groove 121 and the second bus lines 31b and 32b, and capacitance Cg, dependent upon the discharge gas filled in the groove 121.

$$C 17 = C 21 + Cg = 2 \frac{ɛ}{L} + \frac{Eg}{GL} \qquad [ Formula 1 ]$$

where ε is a dielectric constant of the second dielectric layer 21, Eg is a dielectric constant of the discharge gas, and GL is a length of the groove 121 in the first direction of the y-axis.

In addition, the groove 121 of the second dielectric layer 21 opens the front portion of the discharge cell 17 to increase an amount of the visible light irradiated through the front substrate 20, thereby enhancing the luminance.

In order to improve the bright room contrast, the barrier ribs 16 and the second dielectric layer 21 may be colored. For example, when the barrier ribs 16 are colored brown, the second dielectric layer 21 is colored blue in order to realize black by the mixture of the brown and the blue where the second dielectric layer 21 overlaps the barrier ribs 16. In this case, in view of the frontward aperture ratio increasing effect of the discharge cell 17, a case where the groove 121 is formed in the colored second dielectric layer 21 is more effective compared to the case in which the groove is formed on a dielectric layer that is not colored. Therefore, the luminance can be further improved.

Each groove 121 is independently formed within a range of each discharge gap DG between the first barrier rib members 16a spaced apart from each other in the second direction of the x-axis and between the second barrier rib members in the second direction of the z-axis. That is, the groove 121 formed with an individual or independent structure prevents crosstalk that may be generated between the discharge cells 17 adjacent in the second direction of the x-axis. The individual or independent structure of the grooves 121 indicates that the grooves 121 are only formed in the second dielectric layer 21 in areas corresponding to the discharge cells 17 such that the grooves 121 are not formed in the second dielectric layer 21 in areas corresponding to the first barrier rib members 16a of the barrier ribs 16.

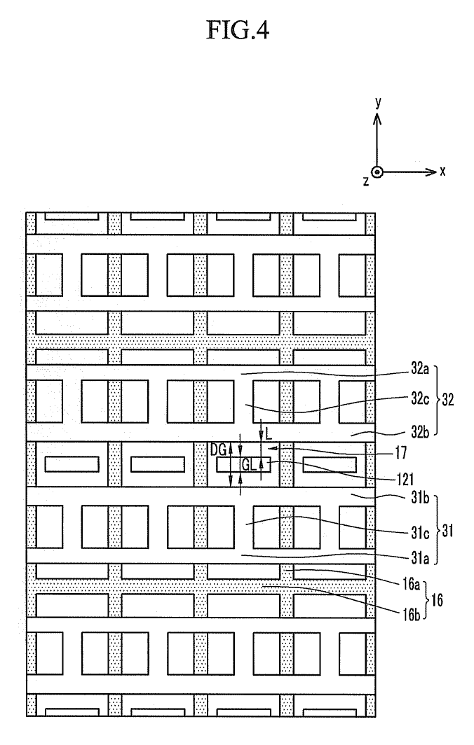

FIG. 4 is a top view illustrating an arrangement of the barrier ribs and the sustain and scan electrodes. Referring to FIG. 4, the sustain and scan electrodes 31 and 32 are formed lengthwise in the second direction of the x-axis and cross the address electrodes 11, which extend in the first direction of the y-axis. FIG. 4 further illustrates the discharge gap DG, the groove length GL, and the distance L. The sustain electrodes 31, including the first bus lines 31a, the second bus lines 31b, and the short bars 31c, and the scan electrodes 32, including the first bus lines 32a, the second bus lines 32b, and the short bars 32c extend to cross the barrier ribs 16, which include first and second barrier rib members 16a and 16b, in the second direction of the x-axis. As the barrier ribs 16 define the discharge cells 17, the sustain and scan electrodes 31 and 32 also extend to cross the discharge cells 17 in the second direction of the x-axis. The discharge gap DG extends from the sustain electrodes 31 in the first direction of the y-axis to the adjacent scan electrodes 32. However, as illustrated in FIG. 4, when the plasma display panel is formed having barrier ribs to include the second barrier rib members 16b, the discharge gap DG is between two adjacent sustain and scan electrodes 31 and 32 that cross the same discharge cell 17 between two adjacent second barrier rib members 16b.

The distance L corresponds to the length between one of the adjacent sustain and scan electrodes 31 and 32 and the nearest edge of the groove 121 in the first direction of the y-axis in the direction of the other of the adjacent sustain and scan electrodes 31 and 32 that crosses the same discharge cell 17, i.e., the distance L extends from one of the adjacent sustain and scan electrodes 31 and 32 to the nearest edge of the groove 121 away from the nearest second barrier rib member 16b. As such, the discharge between two adjacent sustain and scan electrodes 31 and 32 is effected within the discharge cell 17. The groove length GL is the length of the discharge gap DG less twice the distance L. However, the groove length GL is not limited thereto. For example, the distance between one of the sustain and scan electrodes 31 and 32 and the nearest edge of the groove 121 in the first direction of the y-axis may not be equal to the distance between the other of the sustain and scan electrodes 31 and 32 and the nearest edge of the groove 121 in the first direction of the y-axis. Further, the distance between one of the sustain and scan electrodes 31 and 32 and the nearest edge of the groove 121 in the first direction of the y-axis may not be constant such that the groove 121 does not have a rectangular shape as illustrated.

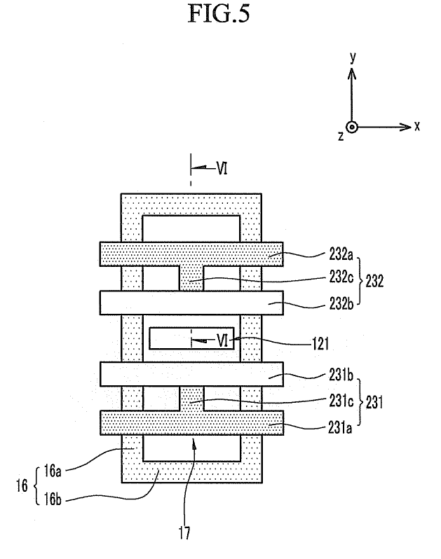

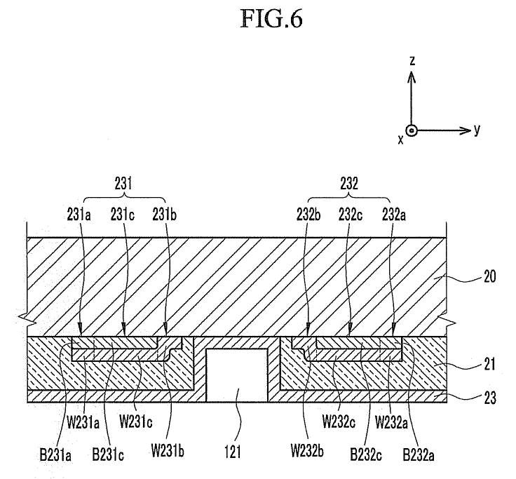

FIG. 5 is a top view illustrating an arrangement of electrodes with respect to one discharge cell in a plasma display panel according to a second embodiment of the present invention, and FIG. 6 is a sectional view taken along line VI-VI of FIG. 5. In view of an overall structure and operational effect, the second embodiment is similar to the first embodiment. Therefore, descriptions of identical parts will be omitted herein and only parts that are different from the first embodiment will be described hereinafter.

In this second embodiment, the sustain and scan electrodes 231 and 232 include first bus lines 231a and 232a, second bus lines 231b and 232b, and short bar 231c and 232c. Like the first embodiment, the first bus lines 231a and 232a and short bars 231c and 232c include black layers B231a, B232a; B231c, and B232c and white layers W231a, W232a; W231c, and W232c, respectively. The black layers B231a, B232a, B231c, and B232c are formed on the front substrate 20, and the white layers W231a, W232a, W231c, and W232c are respectively formed on the black layers B231a, B232a, B231c, and B232c.

The second bus lines 231b and 232b are respectively formed of white layers W231b and W232b. The white layers W231b and W232b are directly formed on the front substrate 20. As the second bus lines 231b and 232b formed of the respective white layers W231b and W232b and do not include the respective black layers B31b and B32b of the first embodiment, they can further reduce the amount of absorption of the visible light while increasing the amount of reflection of the visible light, thereby improving the luminance. The groove 121 is disposed between the sustain and scan electrodes 231 and 232 in an area corresponding to the discharge cell 17 as formed by the barrier ribs 16. The barrier ribs 16 include first and second barrier rib members 16a and 16b.

FIG. 6 is a partial cross-sectional view taken along line VI-VI of FIG. 5. The sustain and scan electrodes 231 and 232 are formed on the surface of the second substrate 20 between the second substrate 20 and the first substrate 10 (not shown). The second dielectric layer 21 is formed to cover the sustain and scan electrodes 231 and 232. The groove 121 is formed in the dielectric layer 21 between the sustain and scan electrodes 231 and 232. The protective layer 23 is disposed to cover the groove 121 and the surface of the second dielectric layer 21.

The sustain and scan electrodes 231 and 232 are formed of the first bus lines 231a and 232a, respectively, the second bus lines 231b and 232b, and the short bars 231c and 232c. Here, the first bus lines 231a and 232a and the short bars 231c and 232c are formed of both black and white layers. The first bus lines 231a and 232a are formed of black layers B231a and B232a. The black layers B231a and B232a are formed on the surface of the second substrate 20 between the second substrate 20 and the first substrate 10 (not shown). The first bus lines 231a and 232a further include white layers W231a and W232a disposed on the black layers B231a and B232a. The short bars 231c and 232c are formed of black layers B231c and B232c. The black layers B231c and B232c are formed on the surface of the second substrate 20 between the second substrate 20 and the first substrate 10 (not shown). The short bars 231c and 232c further include white layers W231c and W232c disposed on the black layers B231c and B232c. However, as described above with respect to FIG. 5, the second bus lines 231b and 232b are only formed of the white layers W231b and W232b. As such, the sustain and scan electrodes 231 and 232 decrease the amount of absorption of the visible light while increasing the amount of reflection of the visible light, thereby improving the luminance.

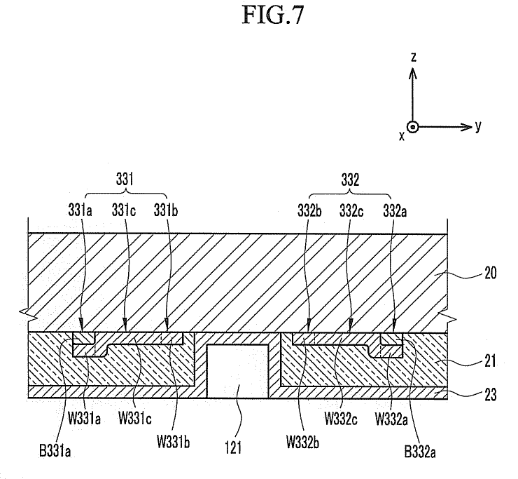

FIG. 7 is a partial cross-sectional view illustrating an electrode and a dielectric layer in a plasma display panel according to a third embodiment of the present invention. The sustain and scan electrodes 331 and 332 are formed on the surface of the second substrate 20 between the second substrate 20 and the first substrate 10 (not shown). The second dielectric layer 21 is formed to cover the sustain and scan electrodes 331 and 332. The groove 121 is formed in the dielectric layer 21 between the sustain and scan electrodes 231 and 232. The protective layer 23 is disposed to cover the groove 121 and the surface of the second dielectric layer 21.

In this third embodiment, the sustain and scan electrodes 331 and 332 include first bus lines 331a and 332a, second bus lines 331b and 332b, and short bar 331c and 332c. Like the first embodiment, the first bus lines 331a and 332a include black layers B331a and B332a and white layers W331a and W332a. The black layers B331a and B332a are formed on the front substrate 20 and the white layers W331a and W332a are formed on the respective black layers B331a and B332a. The short bars 331c and 332c and second bus lines 331b and 332b are respectively formed of only white layers W331c, W332c, W331b, and W332b. The white layers W331c, W332c, W331b, and W332b are directly formed on the front substrate 20.

As the short bars 331c and 332c and second bus lines 331b and 332b formed of the respective white layers W331c, W332c, W331b, and W332b do not include the respective black layers B31c, B32c, B31b, and B32b of the first embodiment, the amount of absorption of the visible light is decreased while the amount of reflection of the visible light is increased, thereby improving the luminance.

FIG. 8 is a partial cross-sectional view of an electrode and a dielectric layer in a plasma display panel according to a fourth embodiment of the present invention. The sustain and scan electrodes 431 and 432 are formed on the surface of the second substrate 20 between the second substrate 20 and the first substrate 10 (not shown). The second dielectric layer 21 is formed to cover the sustain and scan electrodes 431 and 432. The groove 121 is formed in the dielectric layer 21between the sustain and scan electrodes 431 and 432. The protective layer 23 is disposed to cover the groove 121 and the surface of the second dielectric layer 21.

In this fourth embodiment, of the sustain and scan electrodes 431 and 432 include first bus lines 431a and 432a, second bus lines 431b and 432b, and short bars 431c and 432c. The first bus lines 431a and 432a, short bars 431c and 432c, and second bus lines 431b and 432b are respectively formed of white layers W431a, W432a, W431c, W432c, W431b, and W432b. The white layers W431a, W432a, W431c, W432c, W431b, and W432b are directly formed on the front substrate 20.

As the first bus lines 431a and 432a, short bars 431c and 432c, and second bus lines 431b and 432b formed of the respective white layers W431a, W432a, W431c, W432c, W431b, and W432b and do not include the respective black layers B31a, B32a, B31c, B32c, B31b, and B32b of the first embodiment, the absorption of the visible light can be decreased while increasing an amount of reflection of the visible light, thereby improving the luminance.

As described above, in the plasma display panels according to the exemplary embodiments of the present invention, as each of the sustain and scan electrodes is formed with a plurality of bus lines and at least one of the bus lines are formed with only the white layer, the amount of visible light absorbed by the black layers is reduced and thus the luminance can be improved. In addition, in the plasma display panels according to the exemplary embodiments of the present invention, the groove is formed on a portion of the dielectric layer facing the discharge gap, thereby lowering the firing voltage and improving the light emission efficiency by inducing stronger discharge compared to a case where a discharge sustain voltage is applied to the discharge cells and no grooves are formed therein. In addition, by removing a large portion of the colored dielectric layer by forming the groove in the dielectric layer, the aperture ratio of the discharge cell increases and thus the luminance is enhanced.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display panel, comprising:
first and second substrates facing each other and spaced apart from each other;
barrier ribs disposed between the first and second substrates to define discharge cells;
address electrodes formed on the first substrate and extending in a first direction to correspond to the discharge cells;
first and second electrodes formed on the second substrate and extending in a second direction crossing the first direction to correspond to the discharge cells; and
a dielectric layer formed on the second substrate to cover the first and second electrodes and comprising grooves,
wherein the first and second electrodes each comprise a plurality of bus lines of which some of the bus lines form discharge gaps at a central portion of the respective discharge cells, and the grooves are formed within the discharge gap.

2. The plasma display panel of claim 1, wherein the grooves are separately formed in each of the discharge cells.

3. The plasma display panel of claim 1, wherein each of the first and second electrodes comprises:
first bus lines arranged at both sides of the discharge cells in the first direction and extending in the second direction; and
second bus lines spaced apart from the respective first bus lines in the first direction and parallel to the first bus lines,
wherein the second bus lines form the discharge gap.

4. The plasma display panel of claim 3, further comprising short bars to connect the first bus lines to the second bus lines at middle portions, with respect to the second direction, of the discharge cells.

5. The plasma display panel of claim 4, wherein each of the first and second bus lines and the short bars comprises a black layer formed on the second substrate and a white layer formed on the black layer.

6. The plasma display panel of claim 4, wherein each of the first bus lines and short bars comprises a black layer formed on the second substrate and a white layer formed on the black layer; and
each of the second bus lines comprises a white layer formed on the second substrate.

7. The plasma display panel of claim 4, wherein each of the first bus lines comprises a black layer formed on the second substrate and a white layer formed on the black layer; and
each of the short bars and second bus lines comprises a white layer formed on the second substrate.

8. The plasma display panel of claim 4, wherein each of the first bus lines, short bars, and second bus lines comprises a white layer formed on the second substrate.

9. The plasma display panel of claim 1, further comprising a protective layer formed on a surface of the dielectric layer and inner sidewalls of the grooves.

10. The plasma display panel of claim 1, wherein the dielectric layer is blue.

11. The plasma display panel of claim 10, wherein the barrier ribs are brown.

12. A plasma display panel comprising:
first and second substrates facing each other and spaced apart from each other;
barrier ribs disposed between the first and second substrates to define discharge cells;
address electrodes formed on the first substrate and extending in a first direction between the barrier ribs;
first and second electrodes formed on the second substrate and extending in a second direction crossing the first direction to correspond to the discharge cells; and
a dielectric layer formed on the second substrate to cover the first and second electrodes and comprising grooves in a surface of the dielectric layer facing the discharge cells,
wherein the first and second electrodes each comprise a plurality of bus lines of which some of the bus lines form a discharge gap at central portions of the discharge cells, and
at least one of the bus lines comprises a white layer.

13. The plasma display panel of claim 12, wherein each of the first and second electrodes comprises:
first bus lines arranged at both sides of the discharge cells in the first direction and extending in the second direction;
second bus lines spaced apart from the respective first bus lines in the first direction and arranged in parallel to the first bus lines; and
short bars to connect the first bus lines and the second bus lines at middle portions, with respect to the second direction, of the discharge cells,
wherein the second bus lines form the discharge gap.

14. The plasma display panel of claim 13, wherein each of the first bus lines and short bars is formed of black layers and the white layers, and
each of the second bus lines includes the white layer.

15. The plasma display panel of claim 13, wherein each of the first bus lines is formed of black layers and the white layers, and
each of the short bars and second bus lines is formed of a white layer.

16. The plasma display panel of claim 13, wherein each of the first bus lines, short bars, and second bus lines is formed of a white layer.

17. The plasma display panel of claim 1, wherein the grooves extend through the dielectric layer to the second substrate.

18. The plasma display panel of claim 17, further comprising a protective layer formed on a surface of the dielectric layer, inner sidewalls of the grooves, and a surface of the second substrate in the groove.

19. The plasma display panel of claim 17, wherein the grooves open a front of the discharge cells to increase an amount of visible light emitted through the second substrate.

20. The plasma display panel of claim 1, wherein the barrier ribs comprise:
first barrier rib members extending in the first direction, and
second barrier rib members extending in the second direction,
wherein the address electrodes extend parallel to and between the first barrier rib members, and the first and second electrodes extend parallel to and between the second barrier rib members.

21. The plasma display panel of claim 1, wherein the dielectric layer is a first color, the barrier ribs are a second color, and the first and second colors combine to form black.

22. A plasma display panel, comprising:
first and second substrates facing each other and spaced apart from each other;
barrier ribs disposed between the first and second substrates to define discharge cells and comprising first barrier rib members extending in a first direction and second barrier rib members extending in a second direction crossing the first direction;
address electrodes formed on the first substrate and extending in the first direction between the first barrier rib members;
first and second electrodes formed on the second substrate and extending in the second direction between the second barrier rib members; and
a dielectric layer formed on the second substrate to cover the first and second electrodes and comprising grooves formed in a surface of the dielectric layer facing the discharge cells,
wherein the grooves extend from the discharge cells to the second substrate.
